(19) United States
(12) Patent Application Publication
(10) Pub. No.: US 2014/0213246 A1
(43) Pub. Date: Jul. 31, 2014

(54) WIRELESS COMMUNICATION DEVICE AND CONTROL METHOD

(71) Applicant: FUJITSU LIMITED, Kawasaki-shi (JP)

(72) Inventor: Naritoshi SAITO, Hino (JP)

(73) Assignee: FUJITSU LIMITED, Kawasaki-shi (JP)

(21) Appl. No.: 14/087,996

(22) Filed: Nov. 22, 2013

(30) Foreign Application Priority Data
Jan. 25, 2013 (JP) 2013-012702

(51) Int. Cl. H04W 8/02; H04W 88/06

(52) U.S. Cl. CPC H04W 8/02; H04W 88/06
USPC 455/432.1

(57) ABSTRACT

A wireless communication device includes a memory, and a processor coupled to the memory and configured to extract a control code from a signal received through a first communication system that has lower priority than a second communication system prior to carrying out communication through the second communication system, compare the extracted control code with a given control code stored in the memory, determine whether the extracted control code matches the given control code, and cause a communication device that is configured to carry out communication through the second communication system to stop processing for establishing a wireless communication when the processor determines that the extracted control code does not match the given control code.

### CROSS-REFERENCE TO RELATED APPLICATION

This application is based upon and claims the benefit of priority of the prior Japanese Patent Application No. 2013-012702, filed on Jan. 25, 2013, the entire contents of which are incorporated herein by reference.

### FIELD

The embodiments discussed herein are related to wireless communication devices and so forth.

### BACKGROUND

There exists a multi-wireless terminal that is capable of wireless communication through the universal mobile telecommunications system (UMTS) and the time division long term evolution (TD-LTE) system.

Japanese National Publication of International Patent Application No. 2008-543136, Japanese Laid-open Patent Publication No. 2007-235593, and Japanese Laid-open Patent Publication No. 2008-271251 are examples of related art.

### SUMMARY

According to an aspect of the invention, a wireless communication device includes a memory, and a processor coupled to the memory and configured to extract a control code from a signal received through a first communication system that has lower priority than a second communication system prior to carrying out communication through the second communication system, compare the extracted control code with a given control code stored in the memory, determine whether the extracted control code matches the given control code, and cause a communication device that is configured to carry out communication through the second communication system to stop processing for establishing a wireless communication when the processor determines that the extracted control code does not match the given control code.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of multi-wireless system of an embodiment;

FIG. 2 is a functional block diagram illustrating a configuration of a multi-wireless terminal according to the embodiment;

FIG. 3 is a functional block diagram illustrating a configuration of a control unit;

FIG. 4 illustrates an exemplary data structure of a UMTS downlink physical channel;

FIG. 5 illustrates an exemplary data structure of a PLMN code;

FIG. 6 is a flowchart illustrating a processing procedure for obtaining a PLMN code through a UMTS wireless communication;

FIG. 7 illustrates an exemplary data structure of an LTE downlink physical channel;

FIG. 8 is a flowchart illustrating a processing procedure for obtaining a PLMN code through a TD-LTE wireless communication;

FIG. 9 illustrates an exemplary data structure of PLMN code information;

FIG. 10 is a flowchart (1) illustrating a processing procedure of the multi-wireless terminal of the embodiment;

FIG. 11 is a flowchart (2) illustrating the processing procedure of the multi-wireless terminal of the embodiment;

FIG. 12 is a diagram for describing a wireless terminal device that executes a control program;

FIG. 13 illustrates examples of a communication area in which communication is available through the UMTS system and of communication areas in which communication is available through the TD-LTE system; and

FIG. 14 is a flowchart illustrating a processing procedure of a multi-wireless terminal.

### DESCRIPTION OF EMBODIMENTS

Hereinafter, an embodiment of a wireless communication device, a control program, and a control method disclosed herein will be described in detail with reference to the drawings. Embodiments, however, are not limited to the embodiments discussed herein.

While inventing the present embodiments, observations were made regarding a related art. Such observations include the following, for example.

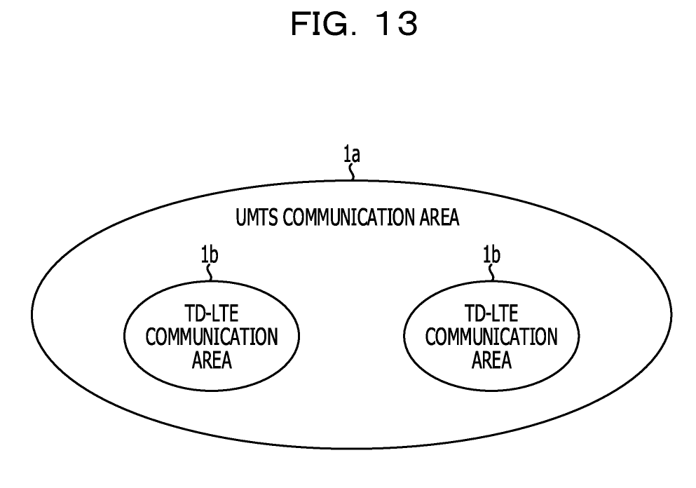

FIG. 13 illustrates examples of a communication area in which communication is available through the UMTS system and of communication areas in which communication is available through the TD-LTE system. Here, a communication area in which communication is available through the UMTS system is referred to as a UMTS communication area 1a, and a communication area in which communication is available through the TD-LTE system is referred to as a TD-LTE communication area 1b. The population coverage rate in the UMTS communication area 1a is 98% or higher. Meanwhile, the population coverage rate in the TD-LTE communication area 1b is approximately 60%.

In general, the communication speed is higher in the TD-LTE system than in the UMTS system. Thus, if a multi-wireless terminal is located at a location within both the UMTS communication area 1a and the TD-LTE communication area 1b, wireless communication through the TD-LTE system takes priority. If the multi-wireless terminal then goes outside the TD-LTE communication area 1b, the multi-wireless terminal switches to the UMTS system to carry out wireless communication. A multi-wireless terminal carries out processing for detecting a TD-LTE base station repeatedly even after the multi-wireless terminal goes outside the TD-LTE communication area 1b in order to determine whether the multi-wireless terminal has entered the TD-LTE communication area 1b again. If the multi-wireless terminal detects a TD-LTE base station, the multi-wireless terminal switches to the TD-LTE system from the UMTS system to carry out wireless communication.

The TD-LTE is the latest wireless service, and thus, for the time being, it is not possible to connect to an overseas service provider by wireless communication through TD-LTE system due to the differences in specifications and so on. In China, for example, although a multi-wireless terminal can receive data through the TD-LTE system, the multi-wireless terminal is unable to transmit data through the TD-LTE system. Thus, even if a user takes a multi-wireless terminal to China, the user is unable to carry out wireless communication through the TD-LTE system. However, if the user carries out wireless communication through the UMTS system, the user can connect to an overseas service provider, which enables overseas roaming.

In order to handle such differences in the specifications, the multi-wireless terminal stops transmitting data through the TD-LTE system once and then receives a public land mobile network (PLMN) code from a broadcast control channel (BCCH) in TD-LTE to determine whether the multi-wireless terminal is located domestically or overseas. If the received PLMN code is not a PLMN code of a domestic service provider, the multi-wireless terminal determines that the multi-wireless terminal is located overseas and thus carries out control for not establishing a wireless communication through the TD-LTE system. Meanwhile, if the PLMN code is a PLMN code of a domestic service provider, the multi-wireless terminal determines that the multi-wireless terminal is not located overseas and thus establishes a wireless communication through the TD-LTE system.

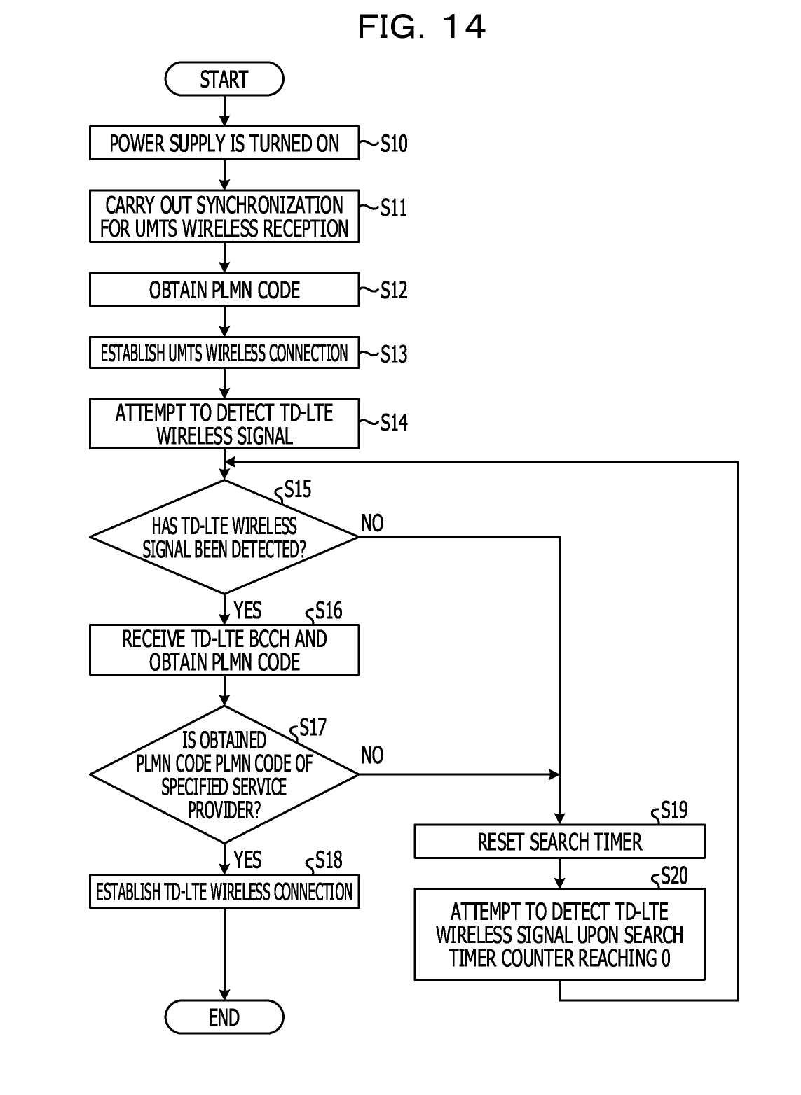

An exemplary processing procedure of the multi-wireless terminal will be described. FIG. 14 is a flowchart illustrating a processing procedure of the multi-wireless terminal. As illustrated in FIG. 14, when the power supply of the multi-wireless terminal is turned on (step S10), the multi-wireless terminal carries out synchronization for UMTS wireless reception (step S11) and obtains a PLMN code (step S12).

The multi-wireless terminal then establishes a UMTS wireless communication (step S13) and attempts to detect a TD-LTE wireless signal (step S14). The multi-wireless terminal determines whether the multi-wireless terminal has detected a TD-LTE wireless signal (step S15). If the multi-wireless terminal has detected a TD-LTE wireless signal (step S15, Yes), the multi-wireless terminal receives a TD-LTE BCCH and obtains a PLMN code (step S16). Thereafter, the multi-wireless terminal determines whether the obtained PLMN code is a PLMN code of a specified service provider (step S17). If the obtained PLMN code is the PLMN code of the specified service provider (step S17, Yes), the multi-wireless terminal establishes a TD-LTE wireless communication (step S18). Meanwhile, if the obtained PLMN code is not the PLMN code of the specified service provider (step S17, No), the multi-wireless terminal proceeds to step S19.

In step S15, if the multi-wireless terminal does not detect a TD-LTE wireless signal (step S15, No), the multi-wireless terminal resets a search timer (step S19). Upon the counter of the search timer reaching 0, the multi-wireless terminal attempts to detect a TD-LTE wireless signal (step S20) and returns to step S15.

As illustrated in FIG. 14, the multi-wireless terminal carries out, at regular intervals, processing in which the multi-wireless terminal receives a PLMN code from a TD-LTE BCCH to determine whether the multi-wireless terminal is located domestically or overseas. For example, in step S17 of FIG. 14, if the PLMN code is not the PLMN code of the specified service provider, the multi-wireless terminal is determined to be located overseas. In this case, the multi-wireless terminal again detects a TD-LTE wireless signal after a given amount of time elapses to determine whether the multi-wireless terminal is located domestically or overseas.

Thus, the technique described above has an issue that power is unnecessarily consumed in the multi-wireless terminal.

The multi-wireless terminal carries out, at regular intervals, processing in which the multi-wireless terminal receives a PLMN code from a TD-LTE BCCH to determine whether the multi-wireless terminal is located domestically or overseas even after the multi-wireless terminal has once determined that the multi-wireless terminal is located overseas, which leads to wasteful power consumption.

In one aspect, a wireless communication device, a control program, and a control method that are capable of reducing power consumption in a multi-wireless terminal is provided.

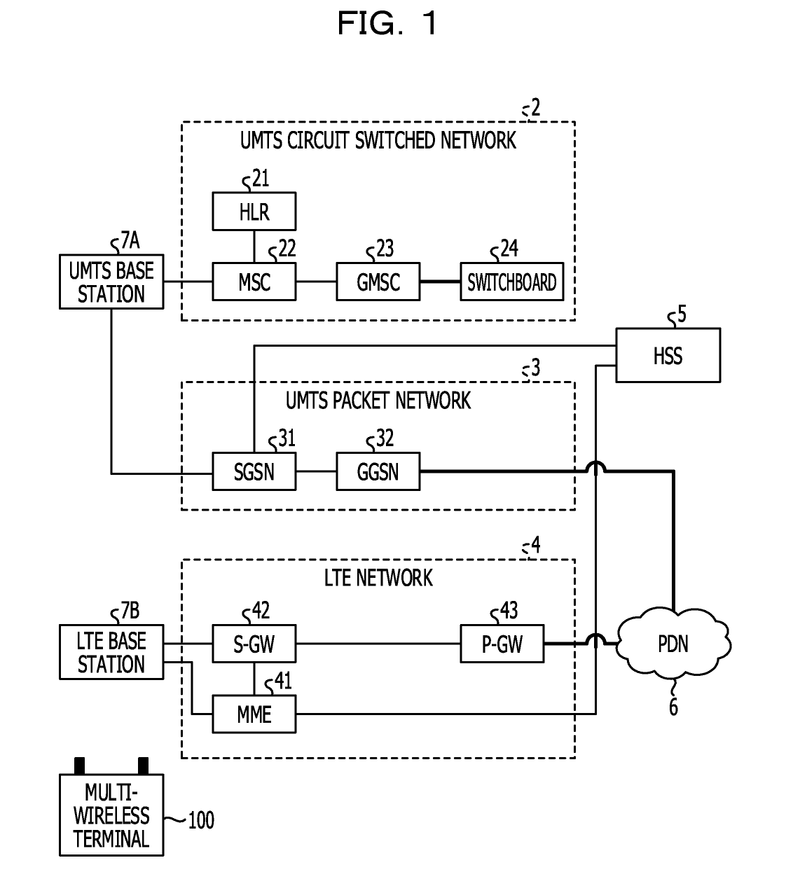

FIG. 1 illustrates an example of a multi-wireless system of an embodiment. As illustrated in FIG. 1, this multi-wireless system includes a UMTS circuit switched network 2, a UMTS packet network 3, an LTE network 4, and a home subscriber server (HSS) 5.

The UMTS circuit switched network 2 is connected to a UMTS base station 7A. The UMTS packet network 3 is connected to the HSS 5, a public data network (PDN) 6, and the UMTS base station 7A. The LTE network 4 is connected to the HSS 5, the PDN 6, and an LTE base station 7B.

The UMTS circuit switched network 2 includes a home location register (HLR) 21, a mobile switching center (MSC) 22, a gateway mobile switching center (GMSC) 23, and a switchboard 24. The HLR 21 registers and manages subscriber information, location information, and authentication information, which are associated with one another, of service subscribers in the UMTS circuit switched network 2. The MSC 22 makes a switched communication with the UMTS base station 7A. The GMSC 23 interconnects the MSC 22 and the switchboard 24.

The UMTS packet network 3 includes a serving GPRS support node (SGSN) 31 and a gateway GPRS support node (GGSN) 32. The SGSN 31 is connected to the HSS 5, the UMTS base station 7A, and the GGSN 32 and relays a packet and so on. The GGSN 32 interconnects the SGSN 31 and the PDN 6.

The LTE network 4 includes a mobility management entity (MME) 41, a serving-gateway (S-GW) 42, and a packet data network gateway (P-GW) 43. The MME 41 is connected to the HSS 5, the LTE base station 7B, and the S-GW 42 and manages network control such as sequence control within the LTE network 4, a handover function, management of locations of service subscribers, and a paging function for an incoming call to the LTE base station 7B. The S-GW 42 is connected to the LTE base station 7B to manage a function of routing a packet. The P-GW 43 is a gateway for connecting to the PDN 6 wirelessly.

The HSS 5 interconnects the SGSN 31 of the UMTS packet network 3 and the MME 41 of the LTE network 4. In addition, the HSS 5 manages subscriber information and so on in the UMTS packet network 3 and the LTE network 4.

A multi-wireless terminal 100 is a terminal of a service subscriber, which is compatible with each wireless communication system within the multi-wireless system illustrated in FIG. 1. The multi-wireless terminal 100 first synchronizes wireless reception with the UMTS base station 7A and receives a UMTS BCCH to obtain a PLMN code. If the obtained PLMN code matches a PLMN code of a specified domestic service provider, the multi-wireless terminal 100 attempts to carry out wireless communication through the TD-LTE system. Meanwhile, if the PLMN code that has been obtained through the UMTS BCCH reception differs from the PLMN code of the specified domestic service provider, the multi-wireless terminal 100 turns off the power supply of a device for establishing a wireless communication through the TD-LTE system. In this way, the multi-wireless terminal 100 turns off the power supply of the device for establishing a wireless communication through the TD-LTE system, and thus the multi-wireless terminal 100 does not attempt wireless communication through the TD-LTE system repeatedly, which makes it possible to reduce power consumption.

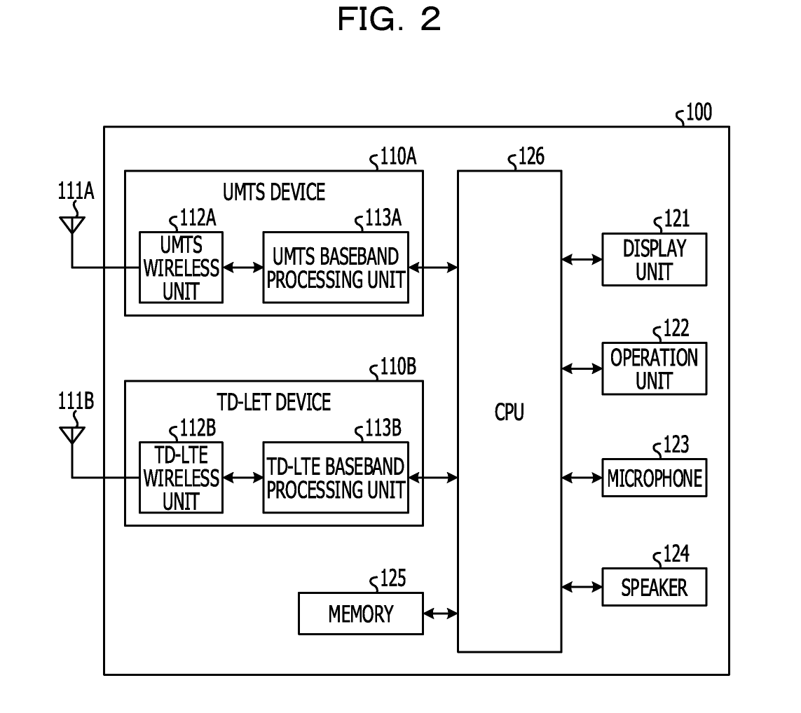

Subsequently, the configuration of the multi-wireless terminal 100 illustrated in FIG. 1 will be described. FIG. 2 is a functional block diagram illustrating the configuration of the multi-wireless terminal according to the embodiment. As illustrated in FIG. 2, the multi-wireless terminal 100 includes a UMTS device 110A and a TD-LTE device 110B. The multi-wireless terminal 100 further includes a display unit 121, an operation unit 122, a microphone 123, a speaker 124, a memory 125, and a central processing unit (CPU) 126. Although not illustrated in FIG. 2, the multi-wireless terminal 100 may further include a Wireless Fidelity (Wi-Fi) device.

The UMTS device 110A is an interface for managing wireless communication with the UMTS circuit switched network 2 and the UMTS packet network 3. The UMTS device 110A includes an antenna 111A, a UMTS wireless unit 112A, and a UMTS baseband processing unit 113A. The UMTS wireless unit 112A receives a wireless signal including various pieces of data such as sound and characters that are compliant with the UMTS system through the antenna 111A and carries out frequency conversion of the received wireless signal. The UMTS baseband processing unit 113A converts the wireless signal that has been subjected to frequency conversion in the UMTS wireless unit 112A to a baseband signal and demodulates the converted baseband signal. In addition, the UMTS baseband processing unit 113A modulates transmission data into a baseband signal. The UMTS wireless unit 112A carries out frequency conversion of the baseband signal that has been modulated in the UMTS baseband processing unit 113A and outputs, through the antenna 111A, a transmission signal obtained by carrying out frequency conversion of the baseband signal.

The TD-LTE device 110B is an interface for managing wireless communication with the LTE network 4. The TD-LTE device 110B includes an antenna 111B, a TD-LTE wireless unit 112B, and a TD-LTE baseband processing unit 113B. The TD-LTE wireless unit 112B receives a wireless signal of various pieces of data such as sound and characters that are compliant with the LTE system through the antenna 111B and carries out frequency conversion of the received wireless signal. The TD-LTE baseband processing unit 113B converts the wireless signal that has been subjected to frequency conversion in the TD-LTE wireless unit 112B to a baseband signal and demodulates the converted baseband signal. In addition, the TD-LTE baseband processing unit 113B modulates transmission data into a baseband signal. The TD-LTE wireless unit 1126 carries out frequency conversion of the baseband signal that has been modulated in the TD-LTE baseband processing unit 113B and outputs, through the antenna 111B, a transmission signal obtained by carrying out frequency conversion of the baseband signal.

The display unit 121 is an output interface for displaying various pieces of information on a screen. The operation unit 122 is an input interface through which various pieces of information are inputted. The microphone 123 is an input interface for collecting various sounds. The speaker 124 is an output interface for outputting various sounds. The memory 125 is an area for storing various pieces of information. The CPU 126 is a device for controlling the multi-wireless terminal 100 as a whole.

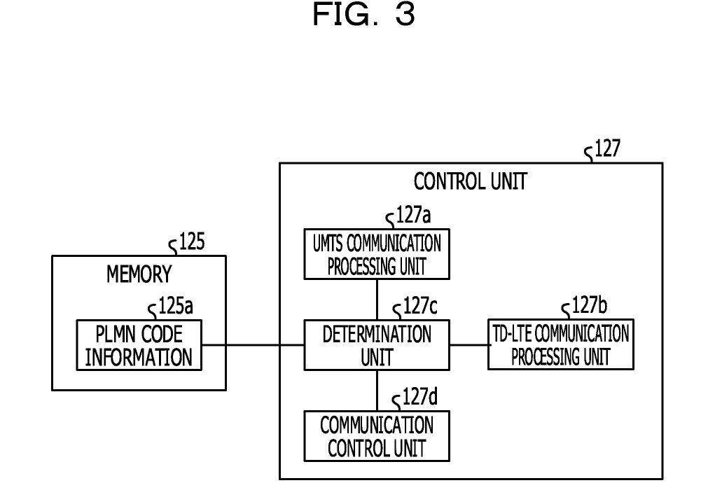

An exemplary configuration of a control unit that is included in the CPU 126 illustrated in FIG. 2 will now be described. FIG. 3 is a functional block diagram illustrating the configuration of the control unit. As illustrated in FIG. 3, a control unit 127 includes a UMTS communication processing unit 127a, a TD-LTE communication processing unit 127b, a determination unit 127c, and a communication control unit 127d.

The UMTS communication processing unit 127a cooperates with the UMTS device 110A to establish a UMTS wireless communication. The UMTS communication processing unit 127a carries out synchronization for UMTS wireless reception to thus obtain a PLMN code. The UMTS communication processing unit 127a outputs information on the PLMN code to the determination unit 127c.

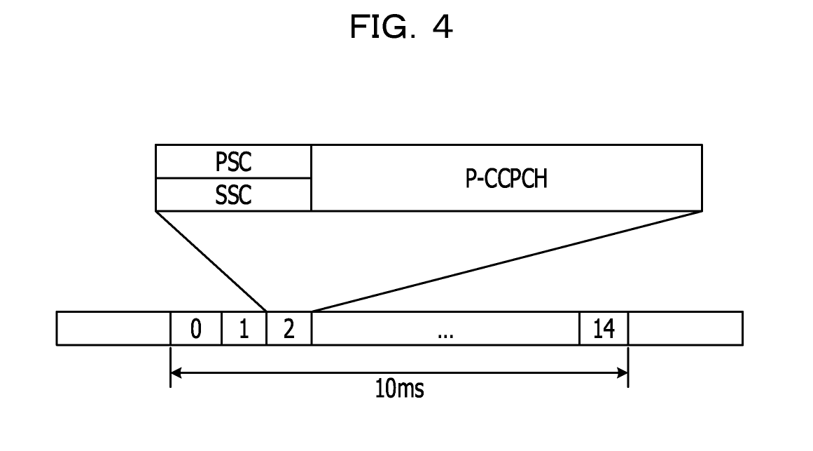

Processing through which the UMTS communication processing unit 127a obtains a PLMN code through a UMTS wireless communication will be described in detail. FIG. 4 illustrates an exemplary data structure of a UMTS downlink physical channel. As illustrated in FIG. 4, UMTS includes frames that are each 10 ms in length and that each consist of 15 slots. Each of the slots includes a primary SCH (PSC), a secondary SCH (SSC), and a P-CCPCH.

The UMTS communication processing unit 127a carries out synchronization processing on the PSC and the SSC to thus demodulate the P-CCPCH and obtains a PLMN code from a master information block (MIB) of a BCCH signal that has been obtained by demodulating the P-CCPCH.

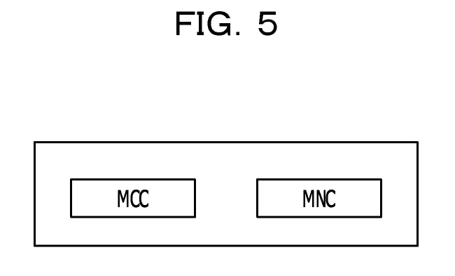

FIG. 5 illustrates an exemplary data structure of the PLMN code. As illustrated in FIG. 5, the PLMN code includes a mobile country code (MCC) and a mobile network code (MNC). For example, a domestic service provider A has a PLMN code where “MCC=440, MNC=20”, and an overseas service provider B has a PLMN code where “MCC=460, MNC=00”. A combination of an MNC and an MCC gives a code that is unique to each company, and thus the determination as to whether the multi-wireless terminal 100 is located domestically or overseas can be made on the basis of a PLMN code.

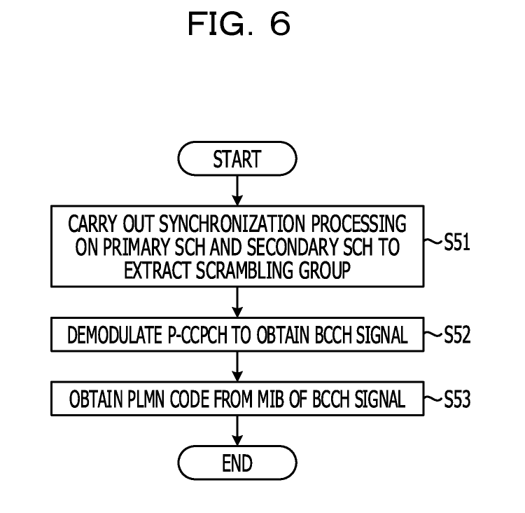

A processing procedure through which the UMTS communication processing unit 127a obtains a PLMN code through a UMTS wireless communication will now be described. FIG. 6 is a flowchart illustrating the processing procedure for obtaining a PLMN code through a UMTS wireless communication. As illustrated in FIG. 6, the UMTS communication processing unit 127a carries out synchronization processing on the primary SCH and on the secondary SCH to thus extract a scrambling group (step S51). The UMTS communication processing unit 127a then demodulates the P-CCPCH to obtain a BCCH signal (step S52) and obtains a PLMN code from the MIB of the BCCH signal (step S53).

The TD-LTE communication processing unit 127b cooperates with the TD-LTE device 110B to establish a wireless communication through the TD-LTE system. The TD-LTE communication processing unit 127b synchronizes TD-LTE wireless reception to obtain a PLMN code. The TD-LTE communication processing unit 127b outputs information on the PLMN code to the determination unit 127c.

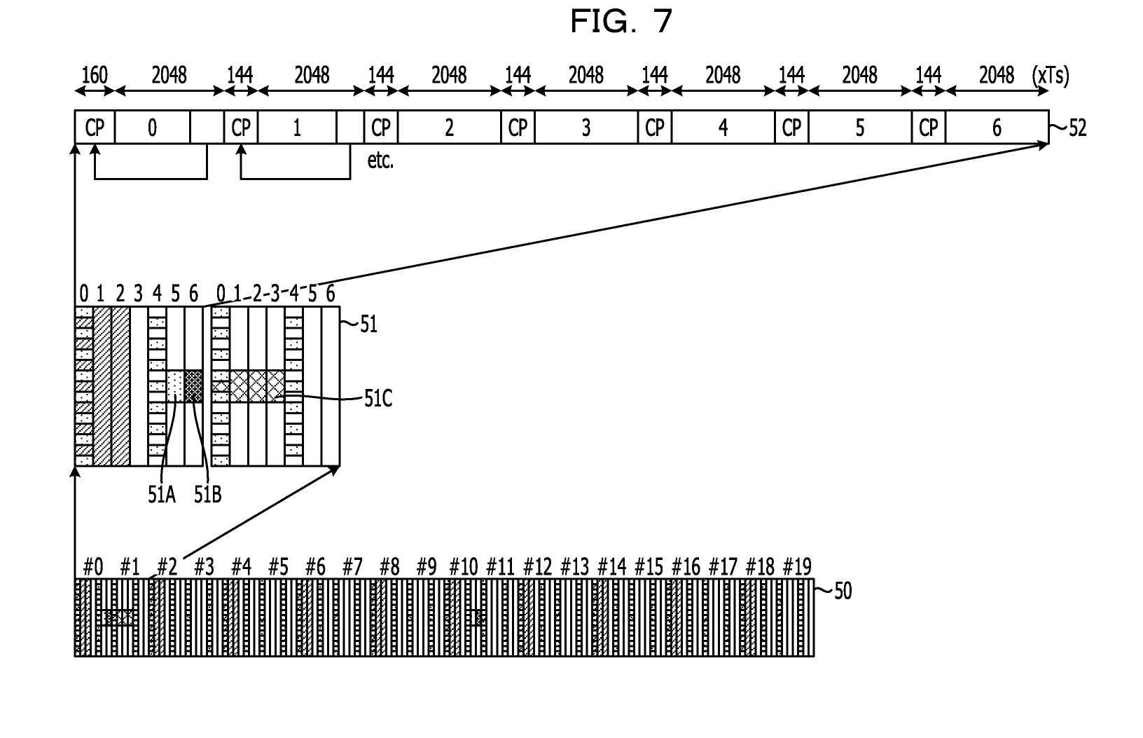

Processing through which the TD-LTE communication processing unit 127b obtains a PLMN code through a TD-LTE wireless communication will now be described in detail. FIG. 7 illustrates an exemplary data structure of an LTE downlink physical channel. As illustrated in FIG. 7, a frame 50 of the LTE downlink physical channel includes a plurality of sub-frames 51, and each of the sub-frames 51 includes a plurality of slots 52.

For example, a single frame is 10 ms in length and includes 10 sub-frames. A single sub-frame is 1 ms in length and includes two slots. A single slot is 0.5 ms in length. Here, each of the sub-frames 51 includes a primary synchronization signal 51A and a secondary synchronization signal 51B for synchronization and a PBCH signal 51C for transporting the BCCH.

The TD-LTE communication processing unit 127b achieves frame synchronization on the basis of the primary synchronization signal 51A and the secondary synchronization signal 51B and extracts a scrambling group for demodulating the PBCH. This scrambling group corresponds to a cell ID. The TD-LTE communication processing unit 127b demodulates the PBCH using the scrambling in order to obtain the BCCH. The TD-LTE communication processing unit 127b obtains a PLMN code that is contained in a system information block 1 (SIB1) of the BCCH. The data structure of the PLMN code is similar to the one illustrated in FIG. 5, and thus description thereof will be omitted here.

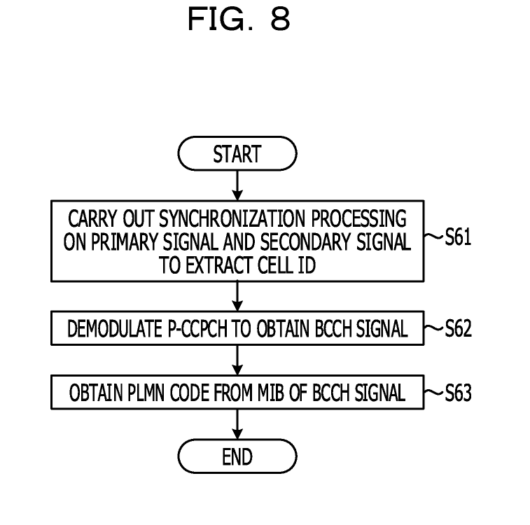

A processing procedure through which the TD-LTE communication processing unit 127b obtains a PLMN code through a TD-LTE wireless communication will now be described. FIG. 8 is a flowchart illustrating the processing procedure for obtaining a PLMN code through a TD-LTE wireless communication. As illustrated in FIG. 8, the TD-LTE communication processing unit 127b carries out synchronization processing on a primary signal and on a secondary signal to thus extract a cell ID (step S61). The TD-LTE communication processing unit 127b then demodulates the P-CCPCH to obtain a BCCH signal (step S62) and obtains a PLMN code from the MIB of the BCCH signal (step S63).

If the power supply of the TD-LTE device 110B is turned off, the TD-LTE communication processing unit 127b stops the processing for obtaining a PLMN code through the TD-LTE wireless communication.

If the TD-LTE communication processing unit 127b obtains information, from the determination unit 127c (described later), indicating that the PLMN code is a PLMN code of a specified service provider in a state where the power supply of the TD-LTE device 110B is turned off, the TD-LTE communication processing unit 127b establishes a TD-LTE wireless communication.

On the other hand, if the TD-LTE communication processing unit 127b obtains information, from the determination unit 127c (described later), indicating that the PLMN code is not the PLMN code of the specified service provider in a state where the power supply of the TD-LTE device 110B is turned off, the TD-LTE communication processing unit 127b, after a given time elapses, obtains a PLMN code again through the TD-LTE wireless communication and outputs the PLMN code to the determination unit 127c.

As described thus far, the UMTS communication processing unit 127a obtains a PLMN code through a UMTS wireless communication. The TD-LTE communication processing unit 127b obtains a PLMN code through a TD-LTE wireless communication. The UMTS communication processing unit 127a carries out the processing for obtaining a PLMN code before the TD-LTE communication processing unit 127b carries out such processing.

In the description hereinafter, a PLMN code that has been obtained through a UMTS wireless communication is referred to as a first PLMN code, and a PLMN code that has been obtained through a TD-LTE wireless communication is referred to as a second PLMN code.

The determination unit 127c is a processing unit for determining whether the first PLMN code received from the UMTS communication processing unit 127a matches a PLMN code of a specified domestic service provider included in PLMN code information 125a. The determination unit 127c outputs a determination result to the communication control unit 127d.

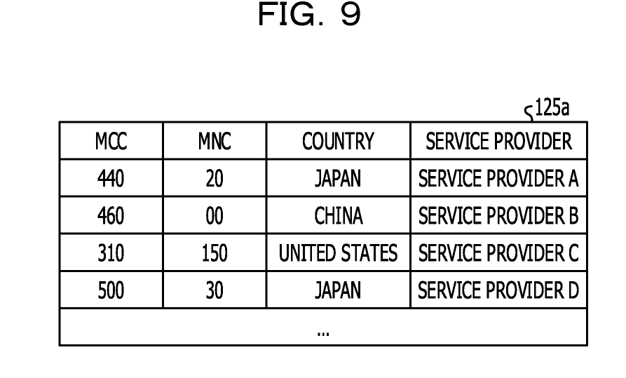

Here, the PLMN code information 125a contains combinations of an MCC and an MNC for respective companies located domestically and combinations of an MCC and an MNC for respective companies located overseas. FIG. 9 illustrates an exemplary data structure of the PLMN code information. For example, the PLMN code information 125a contains MCCs, MNCs, countries, and service providers, which are associated with one another. In the embodiment, a specified domestic service provider having such attributes as the country being “Japan” and the service provider being “provider A” is used as an example.

The determination unit 127c compares the MCC and the MNC in the first PLMN code with the MCCs and the MNCs in the PLMN code information 125a to thus determine whether the first PLMN code matches the PLMN code of the specified Japanese service provider. The determination unit 127c outputs, to the communication control unit 127d, a determination result indicating whether the first PLMN code matches the PLMN code of the specified Japanese service provider.

In addition, the determination unit 127c determines whether the second PLMN code received from the TD-LTE communication processing unit 127b matches the PLMN code of the specified Japanese service provider included in the PLMN code information 125a. The processing for determining whether the second PLMN code matches the PLMN code of the specified Japanese service provider is similar to the above-described processing of the first PLMN code. The determination unit 127c outputs, to the TD-LTE communication processing unit 127b, a determination result indicating whether the second PLMN code matches the PLMN code of the specified Japanese service provider.

The communication control unit 127d is a processing unit for controlling the power supply in TD-LTE on the basis of the determination result of the determination unit 127c. If the communication control unit 127d receives a determination result indicating that the first PLMN code matches the PLMN code of the specified Japanese service provider, the communication control unit 127d turns on the power supply of the TD-LTE device 110B. If the power supply of the TD-LTE device 110B is turned on, the TD-LTE communication processing unit 127b obtains a PLMN code at regular intervals, and if the obtained PLMN code is the PLMN code of the specified service provider, the TD-LTE communication processing unit 127b establishes a TD-LTE wireless communication.

On the other hand, if the communication control unit 127d receives a determination result indicating that the first PLMN code does not match the PLMN code of the specified Japanese service provider, the communication control unit 127d turns off the power supply of the TD-LTE device 110B. While the power supply of the TD-LTE device 110B is being turned off, the TD-LTE communication processing unit 127b does not carry out the processing for obtaining a PLMN code.

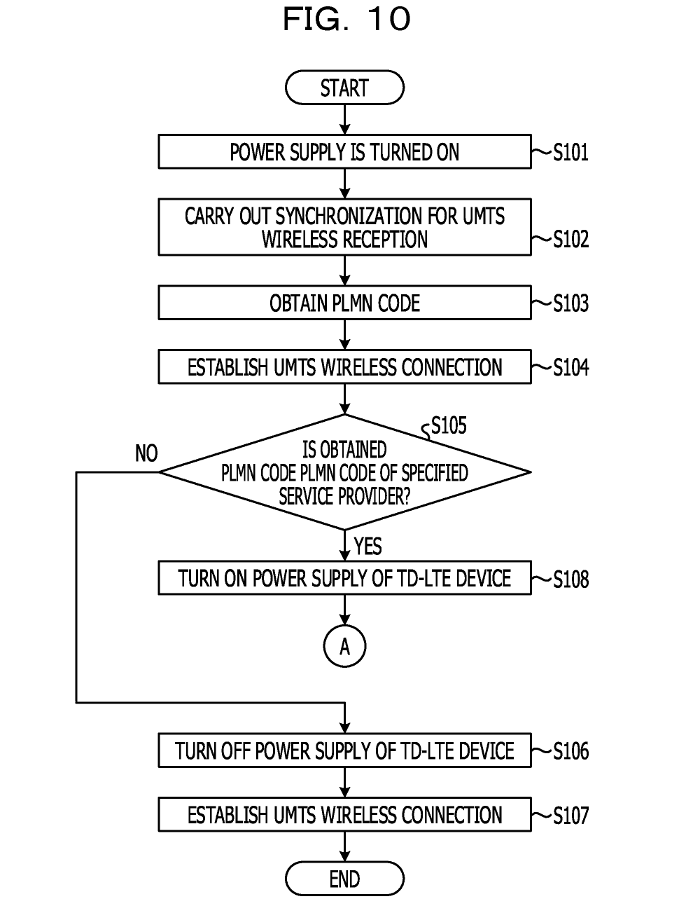

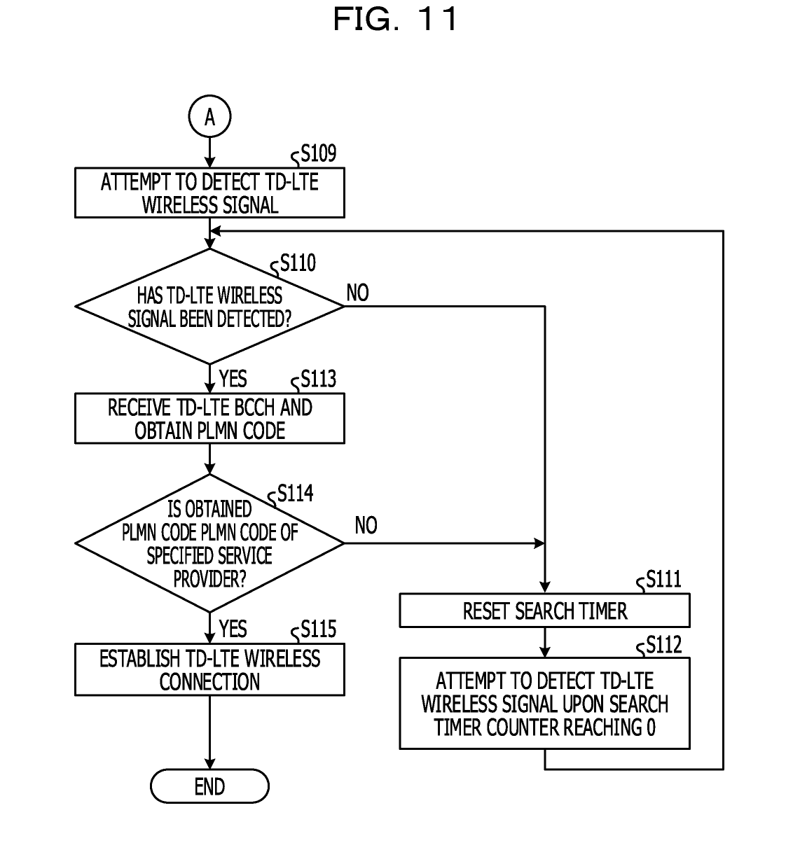

Subsequently, the processing procedure of the multi-wireless terminal 100 of the embodiment will be described. FIGS. 10 and 11 are flowcharts illustrating the processing procedure of the multi-wireless terminal of the embodiment. The processing illustrated in FIGS. 10 and 11 is started, for example, when the power supply of the multi-wireless terminal 100 is turned on. The processing illustrated in FIGS. 10 and 11 may be carried out at given intervals after the power supply is turned on.

As illustrated in FIG. 10, when the power supply of the multi-wireless terminal 100 is turned on (step S101), the multi-wireless terminal 100 carries out synchronization for UMTS wireless reception (step S102) and then obtains a PLMN code (step S103). The multi-wireless terminal 100 then establishes a UMTS wireless communication (step S104).

Thereafter, the multi-wireless terminal 100 determines whether the obtained PLMN code is a PLMN code of a specified service provider (step S105). If the PLMN code is not the PLMN code of the specified service provider (step S105, No), the multi-wireless terminal 100 turns off the power supply of the TD-LTE device 110B (step S106) and establishes a UMTS wireless communication (step S107).

Meanwhile, if the PLMN code is the PLMN code of the specified service provider (step S105, Yes), the multi-wireless terminal 100 turns on the power supply of the TD-LTE device 110B (step S108) and proceeds to step S109 of FIG. 11.

With reference to FIG. 11, the multi-wireless terminal 100 attempts to detect a TD-LTE wireless signal (step S109) and then determines whether the multi-wireless terminal 100 has detected a TD-LTE wireless signal (step S110).

If the multi-wireless terminal 100 does not detect a TD-LTE wireless signal (step S110, No), the multi-wireless terminal 100 resets a search timer (step S111). Upon the counter of the search timer reaching 0, the multi-wireless terminal 100 attempts to detect a TD-LTE wireless signal (step S112) and returns to step S110.

Meanwhile, if the multi-wireless terminal 100 has detected a TD-LTE wireless signal (step S110, Yes), the multi-wireless terminal 100 receives a TD-LTE BCCH and obtains a PLMN code (step S113). Thereafter, the multi-wireless terminal 100 determines whether the PLMN code is the PLMN code of the specified service provider (step S114).

If the PLMN code is not the PLMN code of the specified service provider (step S114, No), the multi-wireless terminal 100 proceeds to step S111. Meanwhile, if the PLMN code is the PLMN code of the specified service provider (step S114, Yes), the multi-wireless terminal 100 establishes a TD-LTE wireless communication (step S115).

Subsequently, the effects of the multi-wireless terminal 100 of the embodiment will be described. The multi-wireless terminal 100 obtains a PLMN code through the UMTS communication system to determine whether the multi-wireless terminal 100 is used domestically prior to the multi-wireless terminal 100 carrying out wireless communication through the TD-LTE communication system. If the multi-wireless terminal 100 is used overseas, the multi-wireless terminal 100 turns off the power supply of the TD-LTE device 110B. As the multi-wireless terminal 100 carries out such processing, a situation where the multi-wireless terminal 100 attempts to detect a TD-LTE wireless signal and to establish a communication at regular intervals even if the TD-LTE is not available overseas can be suppressed, which makes it possible to reduce power consumption.

On the other hand, if the multi-wireless terminal 100 is used domestically, the multi-wireless terminal 100 turns on the power supply of the TD-LTE device 110B and attempts to establish a wireless communication through the TD-LTE communication system at regular intervals. Accordingly, the multi-wireless terminal 100 can carry out, by priority, wireless communication through the TD-LTE communication system, which has a higher communication speed.

Furthermore, the multi-wireless terminal 100 determines whether a PLMN code obtained through the UMTS communication system matches any one of the PLMN codes of the respective domestic service providers contained in the PLMN code information 125a. If the PLMN code obtained through the UMTS communication system does not match any one of the PLMN codes of the respective domestic service providers, the multi-wireless terminal 100 turns off the power supply of the TD-LTE device 110B. Accordingly, a situation where the power supply of the TD-LTE device 110B is accidentally turned off even through the multi-wireless terminal 100 is located domestically can be suppressed.

Another embodiment will now be described. For example, the specifications of Worldwide Interoperability for Microwave Access (WiMAX) differ for each service provider. Thus, with WiMAX, WiMAX roaming through another service provider is currently not available. Accordingly, if the multi-wireless terminal 100 includes a WiMAX device that carries out communication using WiMAX, the multi-wireless terminal 100 may carry out on/off control of the power supply of the WiMAX device, as in the case of the TD-LTE device 110B. In other words, if a PLMN code that has been obtained by receiving a UMTS BCCH differs from the PLMN code of the specified domestic service provider, the multi-wireless terminal 100 may control the WiMAX device to turn off the power supply thereof.

Furthermore, the multi-wireless terminal 100 may hold a TD-LTE roaming list and may carry out on/off control of the power supply of the TD-LTE device 110B using such a roaming list. For example, if a PLMN code obtained by receiving a UMTS BCCH does not match any one of the codes on the TD-LTE roaming list, the multi-wireless terminal 100 may turn off the power supply of the TD-LTE device 110B.

Furthermore, the multi-wireless terminal 100 may be equipped with an evolution-data only (EVDO) device, in place of the UMTS device 110A. The multi-wireless terminal 100 obtains a PLMN code through EVDO system wireless communication, and if the PLMN code differs from the PLMN code of the specified domestic service provider, the multi-wireless terminal 100 controls the TD-LTE device 110B to turn off the power supply thereof.

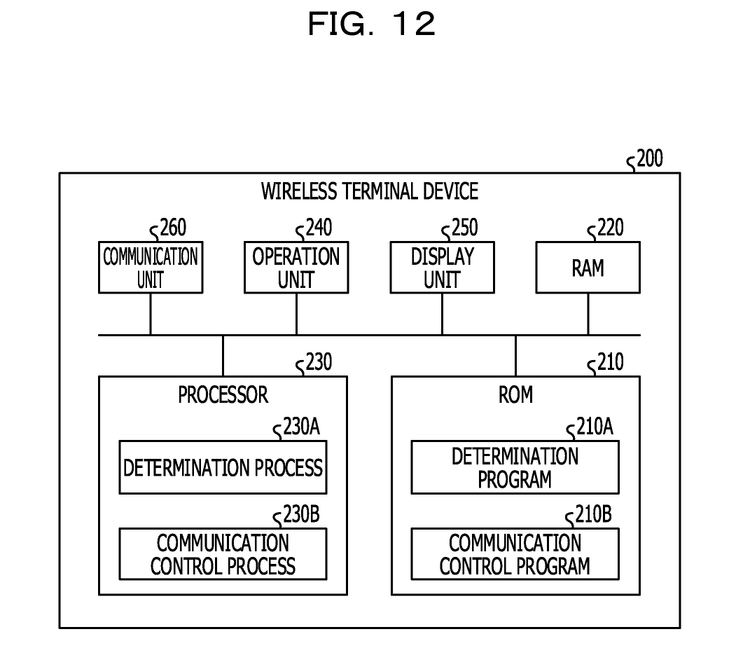

The various processes described in the embodiments above can be realized by a wireless terminal device executing a program prepared in advance. Hereinafter, an example of a wireless terminal device that executes a program having functions similar to those of the embodiments described above will be described. FIG. 12 is a diagram for describing the wireless terminal device that executes a control program.

In FIG. 12, a wireless terminal device 200 that executes the control program includes a ROM 210, a RAM 220, a processor 230, an operation unit 240, a display unit 250, and a communication unit 260. The ROM 210 stores in advance a control program that implements functions similar to those of the embodiments described above. Note that the control program may be recorded in a recording medium, in place of the ROM 210, that can be read by a drive (not illustrated). Such a recording medium may be, for example, a portable recording medium such as a CD-ROM, a DVD disc, a USB memory, and an SD card, a semiconductor memory such as a flash memory, or the like. As illustrated in FIG. 12, the control program includes a determination program 210A and a communication control program 210B. The determination program 210A and the communication control program 210B may be integrated or discrete as appropriate.

The processor 230 loads the determination program 210A and the communication control program 210B from the ROM 210 and executes the loaded determination program 210A and communication control program 210B. Thus, the processor 230 causes the determination program 210A and the communication control program 210B to function as a determination process 230A and a communication control process 230B, respectively. The determination process 230, for example, corresponds to the determination unit 127c illustrated in FIG. 3. The communication control process 230B, for example, corresponds to the communication control unit 127d. The communication unit 260 includes a multi-wireless communication function through multiple communication systems including the LTE system.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication device, comprising:
a memory; and
a processor coupled to the memory and configured to:
extract a control code from a signal received through a first communication system that has lower priority than a second communication system prior to carrying out communication through the second communication system,
compare the extracted control code with a given control code stored in the memory,
determine whether the extracted control code matches the given control code, and
cause a communication device that is configured to carry out communication through the second communication system to stop processing for establishing a wireless communication when the processor determines that the extracted control code does not match the given control code.

2. The wireless communication device according to claim 1,
wherein the processor is configured to
determine whether the control code that has been extracted from the signal received through the first communication system matches any one of control codes of a plurality of service providers located in a specific country, the control codes being stored in the memory, and
cause the communication device that is configured to carry out communication through the second communication system to stop processing for establishing a wireless communication when the extracted control code does not match any one of the control codes of the plurality of service providers.

3. The wireless communication device according to claim 1,
wherein the processor is configured to
extract, as the control code, a PLMN code by carrying out wireless communication through a UMTS communication system prior to carrying out communication through a TD-LTE communication system,
compare the extracted control code with a given control code stored in the memory,
determine whether the extracted control code matches the given control code, and
cause a communication device that is configured to carry out communication through the TD-LTE communication system to stop processing for establishing a wireless communication when the processor determines that the extracted control code does not match the given control code.

4. The wireless communication device according to claim 1,
wherein the processor is configured to
extract, as the control code, a PLMN code by carrying out wireless communication through an EVDO communication system prior to carrying out communication through a TD-LTE communication system, compare the extracted control code with a given control code stored in the memory, determine whether the extracted control code matches the given control code, and
cause a communication device that is configured to carry out communication through the TD-LTE communication system to stop processing for establishing a wireless communication when the processor determines that the extracted control code does not match the given control code.

5. A machine readable medium storing a program that, when executed by a processor, causes the processor to perform operations comprising:
extracting a control code from a signal received through a first communication system that has lower priority than a second communication system prior to carrying out communication through the second communication system;
comparing the extracted control code with a given control code stored in a memory;
determining whether the extracted control code matches the given control code; and
causing a communication device that is configured to carry out communication through the second communication system to stop processing for establishing a wireless communication when it is determined in the determining that the extracted control code does not match the given control code.

6. The machine readable medium storing a program according to claim 5,
wherein the determining determines whether the control code that has been extracted from the signal received through the first communication system matches any one of control codes of a plurality of service providers located in a specific country, the control codes being stored in the memory, and
wherein the causing causes the communication device that is configured to carry out communication through the second communication system to stop processing for establishing a wireless communication when the extracted control code does not match any one of the control codes of the plurality of service providers.

7. The machine readable medium storing a program according to claim 5,
wherein the extracting extracts, as the control code, a PLMN code by carrying out wireless communication through a UMTS communication system prior to carrying out communication through a TD-LTE communication system,
wherein the comparing compares the extracted control code with the given control code stored in the memory,
wherein the determining determines whether the extracted control code matches the given control code, and
wherein the causing causes a communication device that is configured to carry out communication through the TD-LTE communication system to stop processing for establishing a wireless communication when it is determined in the determining that the extracted control code does not match the given control code.

8. The machine readable medium storing a program according to claim 5,
wherein the extracting extracts, as the control code, a PLMN code by carrying out wireless communication through an EVDO communication system prior to carrying out communication through a TD-LTE communication system,
wherein the comparing compares the extracted control code with the given control code stored in the memory,
wherein the determining determines whether the extracted control code matches the given control code, and
wherein the causing causes a communication device that is configured to carry out communication through the TD-LTE communication system to stop processing for establishing a wireless communication when it is determined in the determining that the extracted control code does not match the given control code.

9. A control method, comprising:
extracting a control code from a signal received through a first communication system that has lower priority than a second communication system prior to carrying out communication through the second communication system;
comparing the extracted control code with a given control code stored in a memory;
determining, by a processor, whether the extracted control code matches the given control code; and
causing a communication device that is configured to carry out communication through the second communication system to stop processing for establishing a wireless communication when the determining determines that the extracted control code does not match the given control code.

10. The control method according to claim 9,
wherein the determining determines whether the control code that has been extracted from the signal received through the first communication system matches any one of control codes of a plurality of service providers located in a specific country, the control codes being stored in the memory, and
wherein the causing causes a communication device that is configured to carry out communication through the second communication system to stop processing for establishing a wireless communication when the extracted control code does not match any one of the control codes of the plurality of service providers.

11. The control method according to claim 9,
wherein the extracting extracts, as the control code, a PLMN code by carrying out wireless communication through a UMTS communication system prior to carrying out communication through a TD-LTE communication system,
wherein the comparing compares the extracted control code with the given control code stored in the memory,
wherein the determining determines whether the extracted control code matches the given control code, and
wherein the causing causes a communication device that is configured to carry out communication through the TD-LTE communication system to stop processing for establishing a wireless communication when the determining determines that the extracted control code does not match the given control code.

12. The control method according to claim 9,
wherein the extracting extracts, as the control code, a PLMN code by carrying out wireless communication through an EVDO communication system prior to carrying out communication through a TD-LTE communication system,
wherein the comparing compares the extracted control code with the given control code stored in the memory,
wherein the determining determines whether the extracted control code matches the given control code, and
wherein the causing causes a communication device that is configured to carry out communication through the TD-LTE communication system to stop processing for establishing a wireless communication when it is determined in the determining that the extracted control code does not match the given control code.
